(19) United States
(12) Patent Application Publication
(10) Pub. No.: US 2025/0001580 A1
(43) Pub. Date: Jan. 2, 2025

(54) SADDLE SQUARE

(71) Applicant: Josue dos Santos Moraes, Batavia, IL (US)

(72) Inventor: Josue dos Santos Moraes, Batavia, IL (US)

(73) Assignee: Nomis LLC, Elgin, IL (US)

(21) Appl. No.: 18/742,759

(22) Filed: Jun. 13, 2024

Related U.S. Application Data
(60) Provisional application No. 63/511,009, filed on Jun. 29, 2023.

(51) Int. Cl. B25H 7/04; B43L 7/027

(52) U.S. Cl. CPC B25H 7/04; B43L 7/027

(57) ABSTRACT

A marking alignment tool in the form of a saddle square is provided. The square has first and second legs that define orthogonal workpiece abutment planes and an alignment point. A continuous angle marking channel is provided through the first leg and extends through a top and bottom surface thereof. The channel provides a plurality of marking channel portions that are radially and angularly offset from one another such that a marking tool can be guided at predetermined angular locations relative to a side of a workpiece to form desired marks thereon.

### CROSS-REFERENCE TO RELATED PATENT APPLICATIONS

This Patent Application claims the benefit of U.S. Provisional Patent Application No. 63/511,009, filed Jun. 29, 2023, the entire teachings and disclosure of which are incorporated herein by reference thereto.

### FIELD OF THE INVENTION

This invention generally relates to marking alignment tools and particularly to squares and even more particularly to saddle squares.

### BACKGROUND OF THE INVENTION

Construction and particularly woodworking often has to locate angles and particularly mark angled lines relative to a side of a workpiece for cutting an angle at the end of the workpiece.

Some marking guide tools such as squares have lines demarcated at various angles that allow a user to align a marking tool such as a pencil with a desired angular measurement and form a mark. For instance, a curved channel about a reference point may have a plurality of demarcations at an edge of the channel that represent different angular measurements. Other tools can use straight edges with angled demarcations for identifying where to form a desired mark representing a desired angular offset.

Marking a workpiece using either arrangement suffers from the effects of parallax, which can result in the user aligning the marking tool at an improper location, particularly when the line of sight is not inline with the desired demarcation of the alignment tool.

There is therefore a need to have improved alignment of a marking tool relative to a workpiece for marking at a predetermined angular location.

### BRIEF SUMMARY OF THE INVENTION

The present application provides new and improved alignment tools overcoming the parallax issue. In particular, the present application provides a new and improved square that allows for marking a workpiece at highly accurate angular orientations relative to a side of the workpiece.

In an example, a saddle square configured for forming one or marks on a workpiece at a desired angular position relative to a side of the workpiece is provided. The saddle square includes a first leg and a second leg is provided. The first leg defines a first workpiece abutment plane for abutting a first side of a workpiece. The second defines a second workpiece abutment plane for abutting a second side of the workpiece. The second workpiece abutment plane is generally orthogonal to the first workpiece abutment plane. The first and second legs define an alignment point with the first and second workpiece abutment planes passing through the alignment point. A continuous angle marking channel is formed in the first leg. The continuous angle marking channel includes a plurality of first marking channel portions that are equally angularly spaced about the alignment point. Each first marking channel portion provides a first marking channel abutment portion configured to guide a marking tool for forming a mark on a workpiece at a predetermined angular location relative to the alignment point.

In one example, the first marking channel abutment portion may be radially elongated.

In one example, each of the first marking channel portions are spaced radially outward from the alignment point a same distance.

In one example, the continuous angle marking channel includes a plurality of second marking channel portions. The plurality of second marking channel portions are radially spaced from the plurality of first marking channel portions. The plurality of second marking channel portions are equally angularly spaced apart about the alignment point. Each second marking channel portion provides a first second marking channel abutment portion configured to guide a marking tool for forming a mark on a workpiece at a predetermined angular location relative to the alignment point at a first angular offset from the predetermined angular location of the first marking channel portion of an adjacent first marking channel portion in a first angular direction about the alignment point.

In one example, each second marking channel portion includes a second second marking channel abutment portion configured to guide a marking tool for forming a mark on a workpiece at a predetermined angular location relative to the alignment point at the first angular offset from the predetermined angular location of the first marking channel portion of the adjacent first marking channel portion in a second angular direction, opposite the first angular direction about the alignment point.

In one example, the continuous angle marking channel is continuous such that a marking tool can travel into each of the plurality of first marking channel portions without removing the marking tool from the continuous angle marking channel.

In one example, for each second marking channel portion, the first and second second marking channel abutment portions face one another and form opposed sides of the second marking channel portion.

In one example, the continuous angle marking channel includes a plurality of third marking channel portions. The third marking channel portions are radially spaced from the plurality of second marking channel portions. The plurality of third marking channel portions are equally angularly spaced apart about the alignment point. Each third marking channel portion provides a third marking channel abutment portion configured to guide a marking tool for forming a mark on a workpiece at a predetermined angular location relative to the alignment point and at the first angular offset from the predetermined angular location of a mark formed using the first second abutment portion of the second marking channel portion of an adjacent second marking channel portion in the first angular direction about the alignment point.

The third marking channel portion could include a second third marking channel abutment portion.

In one example, the continuous angle marking channel includes a plurality of fourth marking channel portions. The plurality of fourth marking channel portions are radially spaced from the plurality of second marking channel portions. The plurality of fourth marking channel portions are equally angularly spaced apart about the alignment point. Each fourth marking channel portion provides a fourth marking channel abutment portion configured to guide a marking tool for forming a mark on a workpiece at a predetermined angular location relative to the alignment point and at the first angular offset from the predetermined angular location of a mark formed using the second second abutment portion of the second marking channel portion of an adjacent second marking channel portion in the second angular direction about the alignment point.

In one example, the plurality of fourth marking channel portions are at a same radial spacing from the alignment point as the plurality of third marking channel portions.

In one example, the continuous angle marking channel includes a plurality of fifth marking channel portions and a plurality of sixth marking channel portions. The plurality of fifth marking channel portions are radially spaced from the plurality of third marking channel portions. The plurality of fifth marking channel portions are equally angularly spaced apart about the alignment point. Each fifth marking channel portion provides a fifth marking channel abutment portion configured to guide a marking tool for forming a mark on a workpiece at a predetermined angular location relative to the alignment point and at the first angular offset from the predetermined angular location of a mark formed using the third marking channel abutment portion of an adjacent third marking channel portion in the first angular direction about the alignment point. The plurality of sixth marking channel portions are radially spaced from the plurality of fourth marking channel portions. The plurality of sixth marking channel portions are equally angularly spaced apart about the alignment point. Each sixth marking channel portion provides a sixth marking channel abutment portion configured to guide a marking tool for forming a mark on a workpiece at a predetermined angular location relative to the alignment point and at the first angular offset from the predetermined angular location of a mark formed using the fourth marking channel abutment portion of an adjacent fourth marking channel portion in the second angular direction about the alignment point.

In one example, the continuous angle marking channel includes a plurality of seventh marking channel portions. The plurality of seventh marking channel portions are radially spaced from the plurality of fifth marking channel portions and the plurality of sixth marking channel portions. The plurality of seventh marking channel portions are equally angularly spaced apart about the alignment point. Each seventh marking channel portion provides a first seventh marking channel abutment portion configured to guide a marking tool for forming a mark on a workpiece at a predetermined angular location relative to the alignment point and at the first angular offset from the predetermined angular location of a mark formed using the fifth marking channel abutment portion of an adjacent fifth marking channel portion in a first angular direction about the alignment point. Each seventh marking channel portion includes a second seventh marking channel abutment portion configured to guide a marking tool for forming a mark on a workpiece at a predetermined angular location relative to the alignment point and at the first angular offset from the predetermined angular location of a mark formed using the sixth marking channel abutment portion of the adjacent sixth marking channel portion in the second angular direction.

In one example, the first marking channel abutment portion, first second marking channel abutment portion and the second second marking channel abutment portion of adjacent first and second marking channel portions are aligned such that the first marking channel abutment portion is angularly interposed between the first and second second marking channel abutment portions.

In one example, the fifth and sixth marking channel portions are at a same radial spacing from the alignment point.

In one example, the wherein the third and fourth marking channel portions are at a same first radial spacing from the alignment point and the fifth and sixth marking channel portions are at a same second radial spacing from the alignment point. The second radial spacing is different than the first radial spacing.

In one example, adjacent ones of the first marking channel abutment portions of the plurality of first marking channel portions are angularly spaced apart 10 degrees about the alignment point. Adjacent ones of the first second marking channel abutment portions of the plurality of second marking channel portions are angularly spaced apart 10 degrees about the alignment point. Adjacent ones of the second second marking channel abutment portions of the plurality of second marking channel portions are angularly spaced apart 10 degrees about the alignment point.

In one example, the continuous angle marking channel includes at least eight first marking channel portions spanning an angle of seventy degrees therebetween about the alignment point.

In one example, a first one of the first marking channel portions is angularly spaced from the second workpiece abutment plane about the alignment point by 10 degrees.

In one example, the alignment point is defined by the intersection of an edge of the first leg and the second workpiece abutment plane.

In one example, each first marking channel portion is radially elongated and wherein each first and second second marking channel abutment portion is radially elongated.

In another example, a saddle square including first and second legs is provided. The first leg defines a first workpiece abutment for abutting a first side of a workpiece. The second leg defining a second workpiece abutment for abutting a second side of the workpiece. The second workpiece abutment being generally orthogonal to the first workpiece abutment. The first and second legs define an alignment point with first and second workpiece abutment planes extending through the alignment point. The first leg includes a continuous angle marking channel. The continuous angle marking channel being a stepped channel. The continuous angle marking channel may include a plurality of radially offset levels.

In one example, one of the levels is a second level spaced a second radial distance from the alignment point. The second level includes a plurality of second marking channel portions. Each second marking channel portion has a first second marking channel abutment portion for guiding a marking tool to form a mark on a workpiece aligned with the alignment point. Adjacent ones of the first second marking channel abutment portions are angularly offset from one another about the alignment point by 10 degrees. Each second marking channel portion has a second second marking channel abutment portion for guiding a marking tool to form a mark on a workpiece aligned with the alignment point. Adjacent ones of the second second marking channel abutment portions are angularly offset from one another about the alignment point by 10 degrees. The first and second second marking channel abutment portions of a corresponding second marking channel portion are angularly spaced apart from one another.

In one example, one of the levels is a third level spaced a third radial distance from the alignment point. The third radial distance is less than the second radial distance. The third level includes a plurality of third marking channel portions configured for guiding a marking tool to form marks on a workpiece aligned with the alignment point. Adjacent ones of the third marking channel portions are angularly offset from one another about the alignment point by 10 degrees. The third level includes a plurality of fourth marking channel portions configured for guiding a marking tool to form marks on a workpiece aligned with the alignment point. Adjacent ones of the fourth marking channel portions being angular offset from one another about the alignment point by 10 degrees.

In one example, one of the levels is a fourth level spaced a fourth radial distance from the alignment point. The fourth radial distance is less than the third radial distance. The fourth level includes a plurality of fifth channel portions configured for guiding a marking tool to form marks on a workpiece aligned with the alignment point. Adjacent ones of the fifth marking channel portions are angularly offset from one another about the alignment point by 10 degrees. The fourth level includes a plurality of sixth marking channel portions configured for guiding a marking tool to form marks on a workpiece aligned with the alignment point. Adjacent ones of the sixth marking channel portions are angular offset from one another about the alignment point by 10 degrees.

In one example, one of the levels is a fifth level spaced a fifth radial distance from the alignment point. The fifth radial distance is less than the fourth radial distance. The fifth level includes a plurality of seventh marking channel portions. Each seventh marking channel portion has a first seventh marking channel abutment portion for guiding a marking tool to form a mark on a workpiece aligned with the alignment point. Adjacent ones of the first seventh marking channel abutment portions re angularly offset from one another about the alignment point by 10 degrees. Each seventh marking channel portion has a second seventh marking channel abutment portion for guiding a marking tool to form a mark on a workpiece aligned with the alignment point. Adjacent ones of the second seventh marking channel abutment portions are angularly offset from one another about the alignment point by 10 degrees. The first and second seventh marking channel abutment portions of a corresponding seventh marking channel portion are angularly spaced apart from one another.

In one example, one of the levels is a first level spaced a first radial distance from the alignment point. The first radial distance is greater than the second radial distance. The first level includes a plurality of first marking channel portions configured for guiding a marking tool to form marks on a workpiece aligned with the alignment point. Adjacent ones of the first marking channel portions are angularly offset from one another about the alignment point by 10 degrees.

As noted, the continuous angle marking channel could have more or fewer levels. At a minimum, two levels would be provided. Preferably, levels one through five are provided.

In one example, each third marking channel portion provides a third marking channel abutment portion. Each fourth channel portion provides a fourth marking channel abutment portion. Each fifth channel portion provides a fifth marking channel abutment portion. Each sixth channel portion provides a sixth marking channel abutment portion. No marking channel abutment portion of the continuous angle marking channel is at a same angular position about the alignment point such that no marking channel abutment portion angularly aligns with another marking channel abutment portion of the continuous angle marking channel.

In one example, the saddle square includes a radially extending first discrete marking slot spaced 30 degrees from the second workpiece support plane and angularly aligned about the alignment point with one of the first marking channel portions as well as a radially extending second discrete marking slot spaced 60 degrees from the second workpiece support plane and angularly aligned about the alignment point with a second one of the first marking channel portions. The radially extending first and second discrete marking slots are not connected to one another and are not connected to the continuous angle marking channel.

In one example, a plurality of radially extending discrete marking slots are provided. Each discrete marking slot is angularly between a first seventh marking channel abutment portion and a second seventh marking channel abutment portion of an adjacent seventh marking channel portion.

In one example, the plurality of radially extending discrete marking slots are radially offset from the continuous angle marking channel and adjacent ones of the radially extending discrete marking slots are angularly spaced apart 10 degrees about the alignment point.

In one example, at least one of the radially extending discrete marking slots is located 45 degrees about the alignment point from the second workpiece abutment plane.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of an embodiment of a marking alignment tool;

FIG. 2 is an end view of the marking alignment tool of FIG. 1;

FIG. 3 is an end view of the marking alignment tool of FIG. 1 mounted on a workpiece;

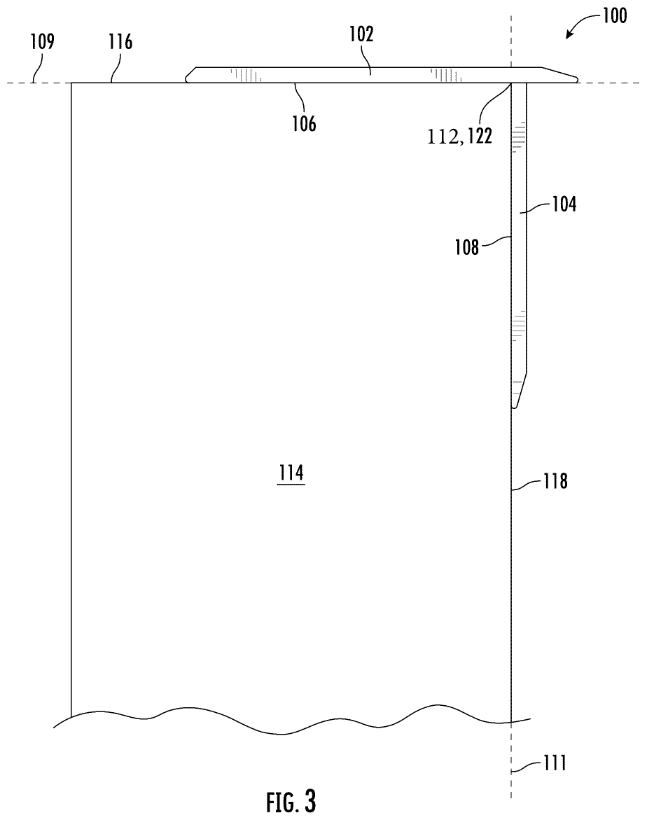

FIG. 4 is a top view of the marking alignment tool of FIG. 1;

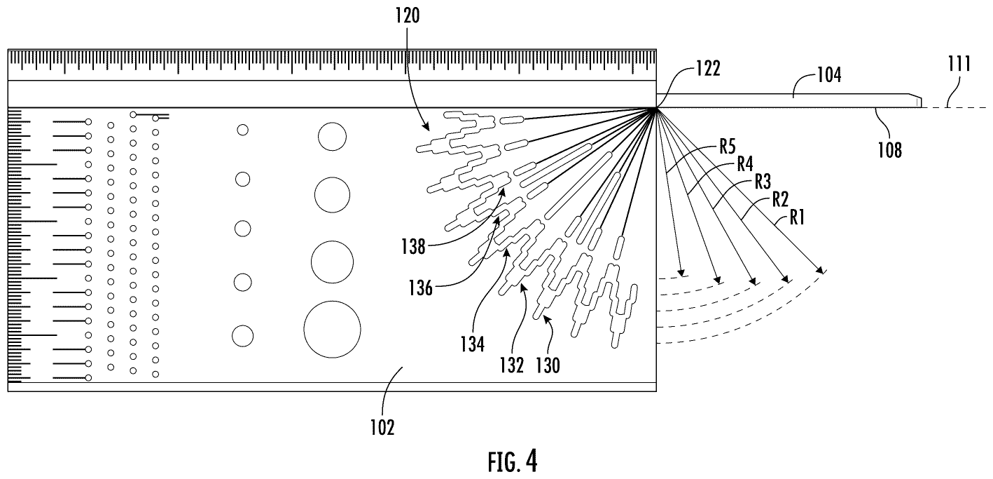

FIG. 5 is an enlarged partial top view of the marking alignment tool of FIG. 1; and

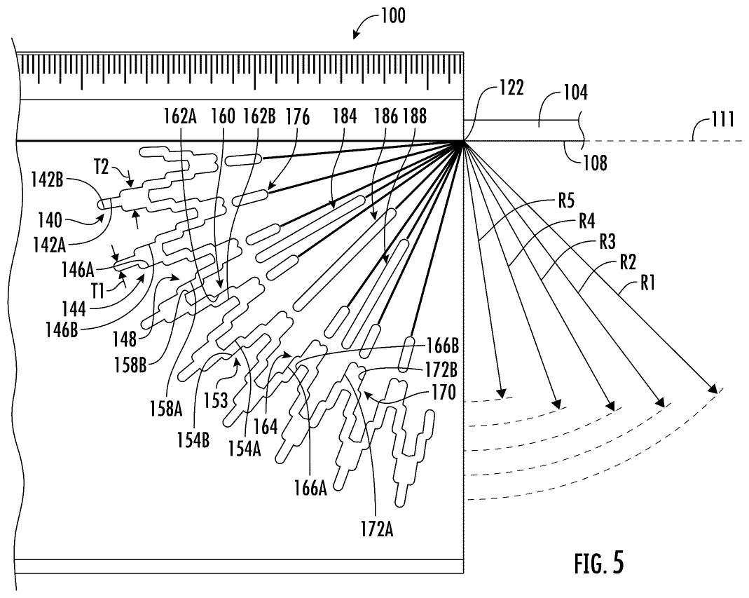

FIG. 6 is a side view of the marking alignment tool of FIG. 1.

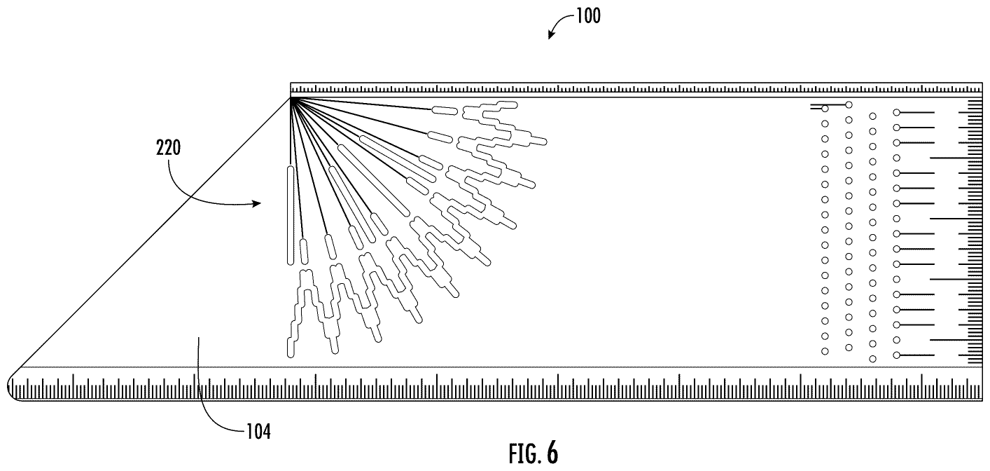

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

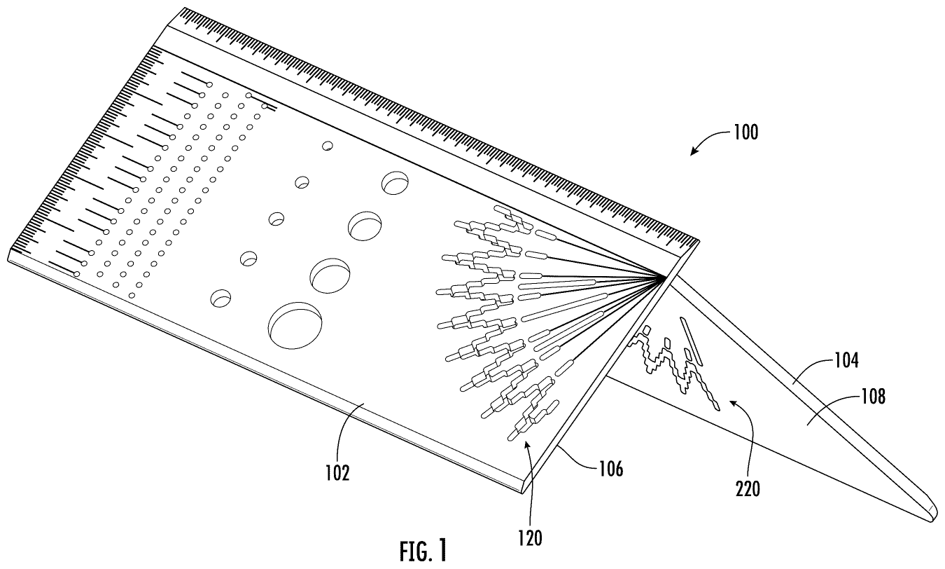

FIG. 1 illustrates a saddle square 100 used for making many measurements and marking many workpieces during construction activities such as woodworking. The saddle square 100 is configured to provide more accurate marking of a workpiece and that addresses the parallax issue outlined above.

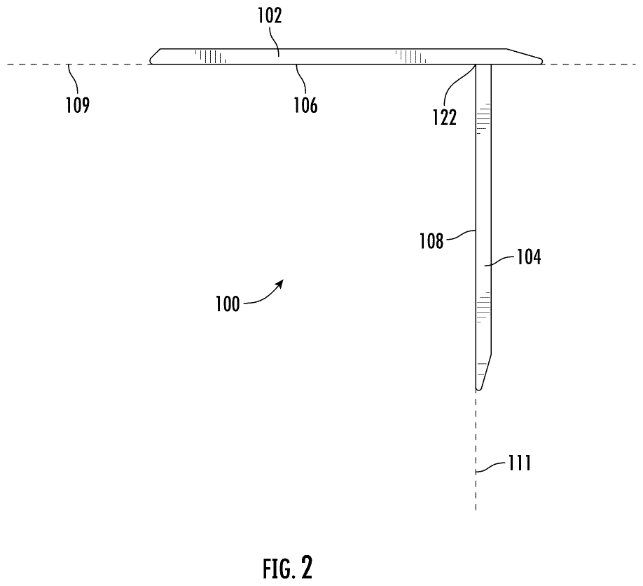

With additional reference to FIG. 2, the saddle square 100 includes a first leg 102 and a second leg 104 that extends orthogonally to first leg 102. The first leg 102 provides a first workpiece abutment 106 that provides a first workpiece abutment plane 109. The second leg 104 provides a second workpiece abutment 108 that provides a second workpiece abutment plane 111. The first and second workpiece abutment planes 109, 111 are preferably orthogonal to one another.

The first and second workpiece abutments 106, 108 are configured to locate the saddle square 100 adjacent an edge 112 of a workpiece 114 defined by orthogonal sides 116, 118.

The saddle square 100 has a plurality of different measurement and marking sections that may be used by a user to mark the workpiece 114 such as for locations where the workpiece 114 is to be cut, drilled or otherwise manipulate the workpiece.

One particular measurement section is used for marking angled lines on the surface of one of the sides 116, 118 of the workpiece 114. In particular, the first leg 102 includes a first angle marking channel 120. This angle marking channel 120 can be used for locating an angled line to be marked on side 116 at a desired angle relative to side 118 that extends through a desired point on edge 112 at the intersection of sides 116, 118.

In particular, the angle marking channel includes a plurality of marking channel portions that are angularly spaced about alignment point 122 for forming marks on side 116.

The alignment point 122, in this example, is aligned with an edge of the first leg 102 that is generally orthogonal to the first workpiece abutment plane 111.

The angle marking channel is a continuous angle marking channel 120 such that the single channel has a plurality of marking abutments for guiding a marking tool such as a pencil or scribe used to mark an angular location that is offset from side 118 (i.e. the second workpiece abutment plane 111) a desired angle and that passes through a desired point.

In this example, the continuous angle marking channel 120 includes a plurality of steps that are angular offset from one another that define individual guide regions for guiding the marking tool.

In the illustrated example, due to the stepped configuration, the continuous angle marking channel 120 may be viewed as having numerous levels. In this example, the continuous angle marking channel 120 includes a first level 130, a second level 132, a third level 134, a fourth level 136 and a fifth level 138.

The first level 130 includes a plurality of first marking channel portions 140 configured for guiding a marking tool to form marks on side 116 of workpiece 114 radially aligned with the alignment point 122. The first marking channel portions 140 are equally angularly spaced apart about alignment point 122. In this example, adjacent ones of the first marking channel portions 140 are angularly offset from one another about the alignment point 122 by ten degrees (10°). Further, the first one of the first marking channel portions 140 is located ten degrees from the second workpiece abutment plane 111.

Thus, if a user wants to form a mark about a desired location on the workpiece that is a multiple of 10 degrees offset from side 118 about a desired point, the user would align the alignment point 122 with the desired point located at the edge 112 on the workpiece 114 and then use the appropriate first marking channel portion 140 to form a reference mark. Thereafter, if desired, the user could align a straight edge with the desired point on edge 112 and the newly formed mark and mark a continuous line between the desired point and the newly marked reference mark. The resulting line would be at the desired angle relative to side 118 and pass through the desired point on edge 112.

The first level 130 and associated first marking channel portions 140 are spaced a first radial distance R1 from the alignment point 122. This distance R1 may be measured to a center point, a radially innermost extent, or a radially outer most extent of the first marking channel portions 140. In the illustrated example, R1 is measured to a radial center point thereof.

The first marking channel portions 140 include at least one, and two in this example, first marking channel abutments 142A, 142B that are radially elongated and that are used to guide the marking tool to form the mark on side 116 of the workpiece 114.

In this example, the spacing between first marking channel abutments 142A, 142B, identified as T1, is substantially equal to the dimension of the marking tool. In one example, the spacing T1 is equal to a 0.9 mm pencil, but other dimensions of a marking tool are contemplated.

The first marking channel abutments 142A are all equally angularly spaced about alignment point 122 and are offset 10 degrees from one another in this example. Similarly, the first marking channel abutments 142B are all equally angularly spaced about alignment point 122 and are offset 10 degrees from one another in this example.

The second level 132 is spaced a second radial distance R2 from the alignment point 122. The second radial distance R2 is less than the first radial distance R1.

The second level 132 includes a plurality of second marking channel portions 144.

Each second marking channel portion 144 has a first second marking channel abutment portion 146A for guiding a marking tool to form a mark on workpiece 114 radially aligned with the alignment point 122. Adjacent ones of the first second marking channel abutments 146A are angularly offset from one another about the alignment point by 10 degrees. The first second marking channel abutments 146A are angularly offset for forming a desired mark 1 degree offset in a first angular direction 150 (illustrated by arrow 150) about alignment point 122 from the location a desired mark would be formed using the adjacent first marking channel portion 140.

Each second marking channel portion 144 has a second second marking channel abutment 146B for guiding a marking tool to form a mark on workpiece 114 radially aligned with the alignment point 122. Adjacent ones of the second second marking channel abutments 146B are angularly offset from one another about the alignment point 122 by 10 degrees. The second second marking channel abutments 146B are angularly offset for forming a desired mark 1 degree offset in a second angular direction 152 (illustrated by arrow 152) about alignment point 122 from the location a desired mark would be formed using the adjacent first marking channel portion 140.

The first and second second marking channel abutments 146A, 146B of a corresponding second marking channel portion 144 are angularly spaced apart from one another to form marks on workpiece 114 that are substantially centered two degrees apart from one another about alignment point 122. For example, if the second marking channel portion 140 is adjacent the first marking channel portion 140 that is 20 degrees offset from second workpiece abutment plane 111, the first second marking channel abutment 146A would be used for marking at 19 degrees offset from second workpiece abutment plane 111 and the second second marking channel abutment 146B would be used for marking at 21 degrees offset from second workpiece abutment plane 111.

The first and second second marking channel abutments 146A, 146B are generally spaced a distance T2 that is double that of distance T1.

The third level 134 is spaced a third radial distance F3 from the alignment point 122. The third radial distance R3 is less than the second radial distance R2.

The third level 134 includes a plurality of third marking channel portions 148 configured for guiding a marking tool to form marks on workpiece 114 radially aligned with the alignment point 122. The plurality of third marking channel portions 148 are equally angularly spaced apart. Adjacent ones of the third marking channel portions 148 are angularly offset from one another about the alignment point 122 by 10 degrees.

Each third marking channel portion 148 includes at least one (and two in the illustrated example) third marking channel abutment 158A, 158B for guiding the marking tool at the desired angular location/orientation relative to the second workpiece abutment plane 111.

Each third marking channel portion 148 is angularly offset from the second marking channel portion 144 in the first angular direction 150 such that a mark formed by the third marking channel portion 148 will be angularly offset from a mark formed by the first second marking channel abutment 146A of the adjacent second marking channel portion 144 by 1 degree in the first angular direction 150.

The third level 134 also includes a plurality of fourth marking channel portions 153 configured for guiding a marking tool to form marks on a workpiece radially aligned with the alignment point 122. The plurality of fourth marking channel portions 153 are equally angularly spaced apart about alignment point 122. Adjacent ones of the fourth marking channel portions 153 are angular offset from one another about the alignment point 122 by 10 degrees.

Each fourth marking channel portion 153 includes at least one (and two in the illustrated example) third marking channel abutment 154A, 154B for guiding the marking tool at the desired angular location/orientation relative to the second workpiece abutment plane 111.

Each fourth marking channel portion 153 is angularly offset from the second marking channel portion 144 in the second angular direction 152 such that a mark formed by the fourth marking channel portion 153 will be angularly offset from a mark formed by the second second marking channel abutment 146B of the adjacent second marking channel portion 144 by 1 degree in the second angular direction 152.

The third and fourth marking channel portions 148, 153 are thus at a same radial spacing R3 from the alignment point 122 but provide different predetermined locations for forming markings on the workpiece 114.

The third and fourth marking channel portions 148, 153 are angularly separated from one another by portions of the first leg 102.

The fourth level 136 is spaced a fourth radial distance R4 from the alignment point 122. The fourth radial distance R4 is less than the third radial distance R3.

The fourth level 136 including a plurality of fifth channel portions 160 configured for guiding a marking tool to form marks on the workpiece 114 radially aligned with the alignment point 122. The plurality of fifth marking channel portions 160 are equally angularly spaced apart. Adjacent ones of the fifth marking channel portions 160 are angularly offset from one another about the alignment point 122 by 10 degrees.

Each fifth marking channel portion 160 includes at least one (and two in the illustrated example) fifth marking channel abutment 162A, 162B for guiding the marking tool at the desired angular location/orientation relative to the second workpiece abutment plane 111.

Each fifth marking channel portion 160 is angularly offset from the adjacent third marking channel portion 148 in the first angular direction 150 such that a mark formed by the fifth marking channel portion 160 will be angularly offset from a mark formed by the third marking channel portion 148 by 1 degree in the first angular direction 150.

The fourth level 136 including a plurality of sixth channel portions 164 configured for guiding a marking tool to form marks on the workpiece 114 radially aligned with the alignment point 122. The plurality of sixth marking channel portions 164 are equally angularly spaced apart. Adjacent ones of the sixth marking channel portions 164 are angularly offset from one another about the alignment point 122 by 10 degrees.

Each sixth marking channel portion 164 includes at least one (and two in the illustrated example) sixth marking channel abutment 166A, 166B for guiding the marking tool at the desired angular location/orientation relative to the second workpiece abutment plane 111.

Each sixth marking channel portion 164 is angularly offset from the adjacent fourth marking channel portion 153 in the second angular direction 152 such that a mark formed by the sixth marking channel portion 164 will be angularly offset from a mark formed by the fourth marking channel portion 153 by 1 degree in the second angular direction 152.

The fifth and sixth marking channel portions 160, 164 are thus at a same radial spacing R4 from the alignment point 122 but provide different predetermined locations for forming markings on the workpiece 114.

The fifth and sixth marking channel portions 160, 164 are angularly separated from one another by portions of the first leg 102.

The fifth level is spaced a fifth radial distance R5 from the alignment point 122. The fifth radial distance R5 is less than the fourth radial distance R4.

The fifth level includes a plurality of seventh marking channel portions 170, which are similar to the second marking channel portions 144 described above.

Each seventh marking channel portion 170 has a first seventh marking channel abutment 172A for guiding a marking tool to form a mark on the workpiece 114 radially aligned with the alignment point 122. Adjacent ones of the first seventh marking channel abutments 172A are angularly offset from one another about the alignment point 122 by 10 degrees. The first seventh marking channel abutments 172A are angularly offset from the adjacent fifth marking channel portion 160 for forming a desired mark 1 degree offset in the first angular direction 150 about the alignment point 122 from the location a desired mark would be formed using the adjacent fifth marking channel portion 160.

Each seventh marking channel portion has a second seventh marking channel abutment 172B for guiding a marking tool to form a mark on the workpiece 114 radially aligned with the alignment point 122. Adjacent ones of the second seventh marking channel abutments are angularly offset from one another about the alignment point by 10 degrees. The second seventh marking channel abutments 172B are angularly offset from the adjacent sixth marking channel portion 164 for forming a desired mark 1 degree offset in the second angular direction 152 about the alignment point 122 from the location a desired mark would be formed using the adjacent sixth marking channel portion 164.

The first and second seventh marking channel abutments 172A, 172B of a corresponding seventh marking channel portion 170 being angularly spaced apart from one another.

The marking channel 120 is a continuous channel such that there are no breaks in the channel such that the first, second third, fourth, fifth, sixth and seventh marking channel portions 140, 144, 148, 153, 160, 164, and 170 are all part of one continuous channel.

In one instance, a marking tool can transition between adjacent first marking channel portions 140 by passing through intervening second, third, fourth, fifth, sixth, seventh and second marking channel portions without removing the marking tool.

The continuous marking channel 120 allows for a user to make marks on the workpiece at predetermined angular at predetermined angular offsets from the second workpiece abutment plane 111.

In this example, no marking channel abutment of the continuous angle marking channel 120 is at a same angular position about the alignment point 122 relative to the second workpiece abutment plane 111 such that no marking channel abutment angularly aligns with another marking channel abutment of the continuous angle marking channel 120.

In this example, in most instances, each first marking channel portion 140 is connected to a corresponding second marking channel portion 144. In most instances, each second marking channel portion 144 is connected to a corresponding third marking channel portion 148 and a corresponding fourth marking channel portion 153. In most instances, each third marking channel portion 148 is connected to a corresponding fifth marking channel portion 160. In most instances, each fourth marking channel portion 153 is connected to a corresponding sixth marking channel portion 164. In most instances, each fifth marking channel portion 160 is connected to a corresponding seventh marking channel portion 170. In most instances, each sixth marking channel portion 164 is connected to a corresponding seventh marking channel portion 170. In most instances, each seventh marking channel portion 170 is connected to a corresponding fifth marking channel portion 160 and a corresponding sixth marking channel portion 164.

However, as illustrated, the corresponding connected marking channel portions are angularly offset so as to provide for different predetermined angular marking locations.

Preferably, the marking channel abutments are elongated relative to the dimension of the intended marking tool so as to allow for a radially elongated mark to be formed.

While generally illustrated as having 10 degree increments, sets of individual marking channels could have different angular spacing. Further, while levels 1-5 are radially stepped in five different radial positions, more or fewer levels could be implements.

While not illustrated, in some embodiments, a sixth level may be provided. The sixth level would be similar to the first level 130 and radially inward of the fifth level and associated seventh marking channel portions 170. Such a level would have eight marking channel portions that would be similar to the first marking channel portions 140. These marking channel portions would be used for forming desired marks at each 5 degree increment (5°, 15°, 25°, 35°, 45°, 55°, 65°, 75°) relative to the second workpiece abutment plane 111 while the first marking channel portions 140, in this example, are used to form desired marks at each 10 degree increment (e.g. 10°, 20°, 30°, 40°, 50°, 60°, 70°,) 80° relative to the second workpiece abutment plane 111.

Similarly, the first level 130 could be removed in some embodiments and only the second-fifth levels 132, 134, 136, 138, may be implemented where the first and hypothetical sixth level are provided by discrete marking slots. However, this arrangement allows for 1 degree increment markings to be made with predetermined abutments.

However, in this example, the 5 degree increment guide features are provided by discrete marking slots 176 that are radially extending and that are aligned with the alignment point 122. Here, each discrete marking slot 176 is positioned angularly between the first and second seventh marking channel abutments 172A, 172B of the adjacent most seventh marking channel portion 170. These discrete marking slots 176 are equally angularly spaced about alignment point 122 and adjacent discrete marking slots 176 are spaced 10 degrees apart about alignment point 122.

The illustrated example also includes three additional discrete marking slots 184, 186, 188 that are aligned at 30°, 45°, and 60° offset from the second workpiece abutment plane 111 as these angular offsets are used more regularly than other angular offsets.

In this example, these three radially elongated marking slots 184, 186, 188 are, optionally, radially longer than slots 176 to illustrate their more typical use. In this example, the second leg 104 includes a second continuous angle marking channel 220 that is substantially identical to the first continuous angle marking channel 120 but that is used for marking at angular positions offset from the first workpiece abutment plane 109.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A saddle square comprising:
a first leg defining a first workpiece abutment plane for abutting a first side of a workpiece;
a second leg defining a second workpiece abutment plane for abutting a second side of the workpiece, the second workpiece abutment plane being generally orthogonal to the first workpiece abutment plane;
the first and second legs defining an alignment point with the first and second workpiece abutment planes passing through the alignment point;
a continuous angle marking channel formed in the first leg, the continuous angle marking channel including:
a plurality of first marking channel portions that are equally angularly spaced about the alignment point, each first marking channel portion providing a first marking channel abutment portion configured to guide a marking tool for forming a mark on a workpiece at a predetermined angular location relative to the alignment point.

2. The saddle square of claim 1, wherein each of the first marking channel portions are spaced radially outward from the alignment point a same distance.

3. The saddle square of claim 1, wherein the continuous angle marking channel includes:
a plurality of second marking channel portions that are radially spaced from the plurality of first marking channel portions, the plurality of second marking channel portions are equally angularly spaced apart about the alignment point, each second marking channel portion providing a first second marking channel abutment portion configured to guide a marking tool for forming a mark on a workpiece at a predetermined angular location relative to the alignment point at a first angular offset from the predetermined angular location of the first marking channel portion of an adjacent first marking channel portion in a first angular direction about the alignment point.

4. The saddle square of claim 3, wherein each second marking channel portion includes a second second marking channel abutment portion configured to guide a marking tool for forming a mark on a workpiece at a predetermined angular location relative to the alignment point at the first angular offset from the predetermined angular location of the first marking channel portion of the adjacent first marking channel portion in a second angular direction, opposite the first angular direction about the alignment point.

5. The saddle square of claim 1, wherein the continuous angle marking channel is continuous such that a marking tool can travel into each of the plurality of first marking channel portions without removing the marking tool from the continuous angle marking channel.

6. The saddle square of claim 4, wherein for each second marking channel portion, the first and second second marking channel abutments face one another and form opposed sides of the second marking channel portion.

7. The saddle square of claim 4, wherein the continuous angle marking channel includes:
a plurality of third marking channel portions that are radially spaced from the plurality of second marking channel portions, the plurality of third marking channel portions are equally angularly spaced apart about the alignment point, each third marking channel portion providing a third marking channel abutment portion configured to guide a marking tool for forming a mark on a workpiece at a predetermined angular location relative to the alignment point and at the first angular offset from the predetermined angular location of a mark formed using the first second abutment portion of the second marking channel portion of an adjacent second marking channel portion in the first angular direction about the alignment point.

8. The saddle square of claim 7, wherein the continuous angle marking channel includes:
a plurality of fourth marking channel portions that are radially spaced from the plurality of second marking channel portions, the plurality of fourth marking channel portions are equally angularly spaced apart about the alignment point, each fourth marking channel portion providing a fourth marking channel abutment portion configured to guide a marking tool for forming a mark on a workpiece at a predetermined angular location relative to the alignment point and at the first angular offset from the predetermined angular location of a mark formed using the second second abutment portion of the second marking channel portion of an adjacent second marking channel portion in the second angular direction about the alignment point.

9. The saddle square of claim 8, wherein the plurality of fourth marking channel portions are at a same radial spacing from the alignment point as the plurality of third marking channel portions.

10. The saddle square of claim 8, wherein the continuous angle marking channel includes:
a plurality of fifth marking channel portions that are radially spaced from the plurality of third marking channel portions, the plurality of fifth marking channel portions are equally angularly spaced apart about the alignment point, each fifth marking channel portion providing a fifth marking channel abutment portion configured to guide a marking tool for forming a mark on a workpiece at a predetermined angular location relative to the alignment point and at the first angular offset from the predetermined angular location of a mark formed using the third marking channel abutment portion of an adjacent third marking channel portion in the first angular direction about the alignment point;
a plurality of sixth marking channel portions that are radially spaced from the plurality of fourth marking channel portions, the plurality of sixth marking channel portions are equally angularly spaced apart about the alignment point, each sixth marking channel portion providing a sixth marking channel abutment portion configured to guide a marking tool for forming a mark on a workpiece at a predetermined angular location relative to the alignment point and at the first angular offset from the predetermined angular location of a mark formed using the fourth marking channel abutment portion of an adjacent fourth marking channel portion in the second angular direction about the alignment point.

11. The saddle square of claim 10, wherein the continuous angle marking channel includes:
a plurality of seventh marking channel portions that are radially spaced from the plurality of fifth marking channel portions and the plurality of sixth marking channel portions, the plurality of seventh marking channel portions are equally angularly spaced apart about the alignment point, each seventh marking channel portion providing a first seventh marking channel abutment portion configured to guide a marking tool for forming a mark on a workpiece at a predetermined angular location relative to the alignment point and at the first angular offset from the predetermined angular location of a mark formed using the fifth marking channel abutment portion of an adjacent fifth marking channel portion in a first angular direction about the alignment point;
wherein each seventh marking channel portion includes a second seventh marking channel abutment portion configured to guide a marking tool for forming a mark on a workpiece at a predetermined angular location relative to the alignment point and at the first angular offset from the predetermined angular location of a mark formed using the sixth marking channel abutment portion of the adjacent sixth marking channel portion in the second angular direction.

12. The saddle square of claim 4, wherein the first marking channel abutment, first second marking channel abutment and the second second marking channel abutment of adjacent first and second marking channel portions are aligned such that the first marking channel abutment is angularly interposed between the first and second second marking channel abutments.

13. The saddle square of claim 10, wherein the fifth and sixth marking channel portions are at a same radial spacing from the alignment point.

14. The saddle square of claim 11, wherein the third and fourth marking channel portions are at a same first radial spacing from the alignment point and the fifth and sixth marking channel portions are at a same second radial spacing from the alignment point, the second radial spacing being different than the first radial spacing.

15. The saddle square of claim 4, wherein:
adjacent ones of the first marking channel abutment portions of the plurality of first marking channel portions are angularly spaced apart 10 degrees about the alignment point;
adjacent ones of the first second marking channel abutment portions of the plurality of second marking channel portions are angularly spaced apart 10 degrees about the alignment point; and
adjacent ones of the second second marking channel abutment portions of the plurality of second marking channel portions are angularly spaced apart 10 degrees about the alignment point.

16. The saddle square of claim 15, wherein the continuous angle marking channel includes at least eight first marking channel portions spanning an angle of seventy degrees therebetween about the alignment point.

17. The saddle square of claim 1, wherein a first one of the first marking channel portions is angularly spaced from the second workpiece abutment plane about the alignment point by 10 degrees.

18. The saddle square of claim 1, wherein the alignment point is defined by the intersection of an edge of the first leg and the second workpiece abutment plane.

19. The saddle square of claim 4, wherein each first marking channel portion is radially elongated and wherein each first and second second marking channel abutment is radially elongated.

20. A saddle square comprising:
a first leg defining a first workpiece abutment for abutting a first side of a workpiece, the first workpiece abutment providing a first workpiece abutment plane;
a second leg defining a second workpiece abutment for abutting a second side of the workpiece, the second workpiece abutment providing a second workpiece abutment plane, the second workpiece abutment plane being generally orthogonal to the first workpiece abutment plane;
the first and second legs defining an alignment point with the first and second workpiece abutment planes extending through the alignment point;
the first leg including a continuous angle marking channel, the continuous angle marking channel being a stepped channel including:
a second level being spaced a second radial distance from the alignment point, the second level including a plurality of second marking channel portions, each second marking channel portion having a first second marking channel abutment for guiding a marking tool to form a mark on a workpiece aligned with the alignment point, adjacent ones of the first second marking channel abutments being angularly offset from one another about the alignment point by 10 degrees, each second marking channel portion having a second second marking channel abutment for guiding a marking tool to form a mark on a workpiece aligned with the alignment point, adjacent ones of the second second marking channel abutments being angularly offset from one another about the alignment point by 10 degrees, the first and second second marking channel abutments of a corresponding second marking channel portion being angularly spaced apart from one another;
a third level being spaced a third radial distance from the alignment point, the third radial distance being less than the second radial distance, the third level including a plurality of third marking channel portions configured for guiding a marking tool to form marks on a workpiece aligned with the alignment point, adjacent ones of the third marking channel portions being angularly offset from one another about the alignment point by 10 degrees, the third level including a plurality of fourth marking channel portions configured for guiding a marking tool to form marks on a workpiece aligned with the alignment point, adjacent ones of the fourth marking channel portions being angular offset from one another about the alignment point by 10 degrees;
a fourth level being spaced a fourth radial distance from the alignment point, the fourth radial distance being less than the third radial distance, the fourth level including a plurality of fifth channel portions configured for guiding a marking tool to form marks on a workpiece aligned with the alignment point, adjacent ones of the fifth marking channel portions being angularly offset from one another about the alignment point by 10 degrees, the fourth level including a plurality of sixth marking channel portions configured for guiding a marking tool to form marks on a workpiece aligned with the alignment point, adjacent ones of the sixth marking channel portions being angular offset from one another about the alignment point by 10 degrees; and
a fifth level being spaced a fifth radial distance from the alignment point, the fifth radial distance being less than the fourth radial distance, the fifth level including a plurality of seventh marking channel portions, each seventh marking channel portion having a first seventh marking channel abutment for guiding a marking tool to form a mark on a workpiece aligned with the alignment point, adjacent ones of the first seventh marking channel abutments being angularly offset from one another about the alignment point by 10 degrees, each seventh marking channel portion having a second seventh marking channel abutment for guiding a marking tool to form a mark on a workpiece aligned with the alignment point, adjacent ones of the second seventh marking channel abutments being angularly offset from one another about the alignment point by 10 degrees, the first and second seventh marking channel abutments of a corresponding seventh marking channel portion being angularly spaced apart from one another.

21. The saddle square of claim 20 wherein the continuous angle marking channel includes a first level being spaced a first radial distance from the alignment point, the first radial distance being greater than the second radial distance, the first level including a plurality of first marking channel portions configured for guiding a marking tool to form marks on a workpiece aligned with the alignment point, adjacent ones of the first marking channel portions being angularly offset from one another about the alignment point by 10 degrees.

22. The saddle square of claim 20, wherein:
each third marking channel portion provides a third marking channel abutment, each fourth channel portion provides a fourth marking channel abutment, each fifth channel portion provides a fifth marking channel abutment portion, each sixth marking channel portion provides a sixth marking channel abutment portion; and
wherein no marking channel abutment of the continuous angle marking channel is at a same angular position about the alignment point such that no marking channel abutment angularly aligns with another marking channel abutment of the continuous angle marking channel.

23. The saddle square of claim 21, further including a radially extending first discrete marking slot spaced 30 degrees from the second workpiece support plane and angularly aligned about the alignment point with one of the first marking channel portions and a radially extending second discrete marking slot spaced 60 degrees from the second workpiece support plane and angularly aligned about the alignment point with a second one of the first marking channel portions, the radially extending first and second discrete marking slots not being connected to one another and not being connected to the continuous angle marking channel.

24. The saddle square of claim 20, further including a plurality of radially extending discrete marking slots, each discrete marking slot being angularly between a first seventh marking channel abutment and a second seventh marking channel abutment of an adjacent seventh marking channel portion.

25. The saddle square of claim 24, wherein the plurality of radially extending discrete marking slots are radially offset from the continuous angle marking channel and adjacent ones of the radially extending discrete marking slots are angularly spaced apart 10 degrees about the alignment point.

26. The saddle square of claim 24, wherein at least one of the radially extending discrete marking slots is located 45 degrees about the alignment point from the second workpiece abutment plane.
